(19) United States
(12) Patent Application Publication
(10) Pub. No.: US 2020/0314775 A1
(43) Pub. Date: Oct. 1, 2020

(54) SYSTEMS AND METHODS FOR RAN SLICING SYNCHRONIZATION CHANNEL DESIGN

(71) Applicant: Huawei Technologies Co., Ltd., Shenzhen (CN)

(72) Inventors: Hua Xu, Ottawa (CA); Jianglei Ma, Ottawa (CA); Zhenfei Tang, Ottawa (CA)

(21) Appl. No.: 16/369,224

(22) Filed: Mar. 29, 2019

(51) Int. Cl. H04W 56/00; H04W 76/27; H04L 12/24

(52) U.S. Cl. CPC H04W 56/001; H04W 88/02; H04L 41/5003; H04W 76/27

(57) ABSTRACT

Systems and methods of synchronization channel design for radio access network (RAN) slicing are described. According to embodiments, a user equipment (UE) receives, from a first transmit point in a radio access network (RAN), a first synchronization signal over a first synchronization channel. The first synchronization channel is associated with a first RAN slice of a plurality of RAN slices in the RAN. The plurality of RAN slices comprise a second RAN slice associated with a second synchronization channel. The first synchronization channel and the second synchronization channel are different from a default synchronization channel of the first transmit point.

### TECHNICAL FIELD

The present application relates to wireless communication generally, and, in particular embodiments, to a system and method of synchronization channel design for radio access network (RAN) slicing.

### BACKGROUND

New Radio (NR) has introduced slicing techniques to enable more efficient support of various services in the same network infrastructure. Slicing techniques can be applied in a core network (CN) and a RAN, respectively. The RAN provides wireless communication channels to user equipments (UEs), while the CN is typically comprised of nodes and functions making use of fixed links. In the RAN, radio access between a base station and a user equipment (UE) is wireless, while the backhaul connections of the RAN can be wired or wireless connections.

Services supported by RAN slicing can fall within a range of categories including, for example, enhanced mobile broadband (eMBB) communications (such as bi-directional video communications and streaming media content delivery); ultra-reliable and low latency communications (URLLC); and massive Machine Type Communications (mMTC). A RAN slice can be service specific. For instance, one RAN slice of a network may provide an eMBB service, another RAN slice of the network may provide a URLLC service, and yet another RAN slice of the network may provide an mMTC service.

A RAN slice may consist of one or more of the following components: one or more sets of transmit/receive nodes/points and user equipments (UEs); one or more sets of transmission schemes; one or more sets of time/frequency/beam/cell resources; mechanism of initial access procedures; mechanism of handover (HO) procedures; and one or more sets of state machines for managing UE states, such as the active state, the inactive (ECO) state, and the idle state. Currently, in a network with multiple RAN slices/services, only one synchronization channel (often called the default synchronization channel) is supported by the UE.

### SUMMARY

Technical advantages are generally achieved by embodiments of this disclosure which describe systems and methods of synchronization channel design for radio access network (RAN) slicing.

According to embodiments, a user equipment (UE) receives, from a first transmit point in a radio access network (RAN), a first synchronization signal over a first synchronization channel. The first synchronization channel is associated with a first RAN slice of a plurality of RAN slices in the RAN. The plurality of RAN slices comprise a second RAN slice associated with a second synchronization channel. The first synchronization channel and the second synchronization channel are different from a default synchronization channel of the first transmit point.

The UE performs a first synchronization procedure based on the first synchronization signal over the first synchronization channel, before the UE accesses a first service provided by the first RAN slice.

In some embodiments, before the UE receives the first synchronization signal over the first synchronization channel, the UE may receive a synchronization signal over the default synchronization channel. The plurality of RAN slices may comprise a default RAN slice associated with the default synchronization channel. The UE may perform a synchronization procedure based on the synchronization signal over the default synchronization channel before the UE accesses a default service provided by the default RAN slice. UE may receive configuration information of the first synchronization channel. The UE may then receive the first synchronization signal over the first synchronization channel associated with a first RAN slice.

In some embodiments, to receive the configuration information of the first synchronization channel, the UE may receive the configuration information of the first synchronization channel in one of a system information message, a radio resource control (RRC) message, or a slicing configuration message.

In some embodiments, the first synchronization channel may be transmitted on a first bandwidth part (BWP). The second synchronization channel may be transmitted on a second BWP. The second BWP may be different from the first BWP.

In some embodiments, the first synchronization channel may use a first time-frequency resource. The second synchronization channel may use a second time-frequency resource. The second time-frequency resource may be different from the first time-frequency resource. In some embodiments, the first time-frequency resource may at least partially overlap with the second time-frequency resource.

In some embodiments, the first synchronization channel may use a first beam resource. The second synchronization channel may use a second beam resource. The second beam resource may be different from the first beam resource. In some embodiments, the first beam resource may at least partially overlap with the second beam resource. In some embodiments, the first beam resource may be associated with one or more narrow beams. The second beam resource may be associated with one or more wide beams.

In some embodiments, the first synchronization channel may use a first synchronization sequence. The second synchronization channel uses a second synchronization sequence. The second synchronization sequence may be different from the first synchronization sequence. In one embodiment, the second synchronization sequence may be partially extracted from the first synchronization, and the first and the second synchronization sequences may transmit on the same symbol. In another embodiment, the first and the second synchronization sequences may have different lengths and transmit on the same symbol. In yet another embodiment, the first and the second synchronization sequences may have different lengths and transmit on the different symbols.

In some embodiments, the first RAN slice provides a first set of one or more services. The first set of one or more services may have a first quality of service (QoS) requirement. The second RAN slice may provide a second set of one or more services. The second set of one or more services may have a second QoS requirement. The second QoS requirement may be different from the first QoS requirement. In some embodiment, the second QoS requirement may have a higher latency or a higher reliability requirement than the first QoS requirement. Examples of a QoS requirement include at least one of a latency requirement, a jitter requirement, a packet ordering requirement, a dropped-packet rate, a throughput requirement, or an error rate.

In some embodiments, different synchronization channels for different RAN slices may use different synchronization signal block (SSB) configurations. For example, the first synchronization channel may use a first SSB configuration. The second synchronization channel may use a second SSB configuration different from the first SSB configuration. The first SSB configuration and the second SSB configuration may both be different from a default SSB configuration used by the default synchronization channel.

In some embodiments, the UE may receive, from a second transmit point in the RAN, a second synchronization signal over a second synchronization channel. The second transmit point may be the same as or different from the first transmit point. The second synchronization channel may be associated with the second RAN slice of the plurality of RAN slices in the RAN. The UE may then perform a second synchronization procedure based on the second synchronization signal over the second synchronization channel, before the UE accesses a second service provided by the second RAN slice. In one embodiment, the UE may not maintain synchronization on the default synchronization channel after performing the second synchronization procedure if the UE does not support the service on the default RAN slice associated with the default synchronization channel. In another embodiment, the UE may still maintain synchronization on the default synchronization channel after performing the second synchronization procedure if the UE still supports the service on the default RAN slice associated with the default synchronization channel.

In some embodiments, the UE may receive, from a third transmit point in the RAN, a third synchronization signal over a third synchronization channel. The third transmit point may be the same as or different from the second transmit point or the first transmit point. The third synchronization channel may be associated with the third RAN slice of the plurality of RAN slices in the RAN. The UE may then perform a third synchronization procedure based on the third synchronization signal over the third synchronization channel, before the UE accesses a third service provided by the third RAN slice. The third RAN slice may provide a third set of one or more services. The third set of one or more services may have a third QoS requirement different from the first and the second QoS requirement. In one embodiment, the UE may synchronize on the default synchronization channel, the first synchronization channel, and the second synchronization channel at the same time. The third synchronization channel may use a third SSB configuration different from the default SSB configuration, the first SSB configuration, and the second SSB configuration.

Apparatuses, as well as computer program products, for performing the methods are also provided.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a diagram of an embodiment wireless network for communicating data;

FIG. 2 shows an example of a network with RAN slicing;

FIG. 3A shows examples of different synchronization channels using different synchronization resources for different RAN slices;

FIG. 3B illustrates an example embodiment of different synchronization sequence sources for different synchronization channels on the same orthogonal frequency-division multiplexing (OFDM) symbol;

FIG. 3C illustrates an additional example embodiment of different synchronization sequence sources for different synchronization channels on different OFDM symbols;

FIG. 4 shows an example of using different sets of synchronization signal blocks (SSBs) for different synchronization channels, according to some embodiments;

FIG. 5 shows an example embodiment of using different beam resources for different synchronization channels;

FIG. 6 illustrates the approach of the two-step synchronization procedure, according to some embodiments;

FIGS. 7A-7C illustrates additional examples of the synchronization procedures for multiple RAN slices;

FIG. 8 shows a flowchart of a method for RAN slicing synchronization, according to some embodiments;

FIG. 9 shows a block diagram of an embodiment processing system for performing methods described herein; and

FIG. 10 shows a block diagram of a transceiver adapted to transmit and receive signaling over a telecommunications network.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In a conventional network system with multiple RAN slices/services, only one synchronization channel (often called a default synchronization channel) is supported by the UE. However, the current synchronization channel design in the conventional network system poses technical problems. Applications associated with different services have different service requirements, such as reliability and latency requirements. Using only one synchronization channel across multiple RAN slices/services does not accommodate well the specific service requirements (e.g., reliability and latency) of different RAN slices/services. To solve these technical problems, embodiments of this disclosure provide technical solutions that support multiple synchronization channels at the same time for multiple RAN slices/services of a RAN network. In doing so, the disclosed embodiment techniques described below provide more flexibility in synchronization for supporting multiple RAN slices/services in a network than the conventional systems, which in turn improve the resource utilization and performance of the network.

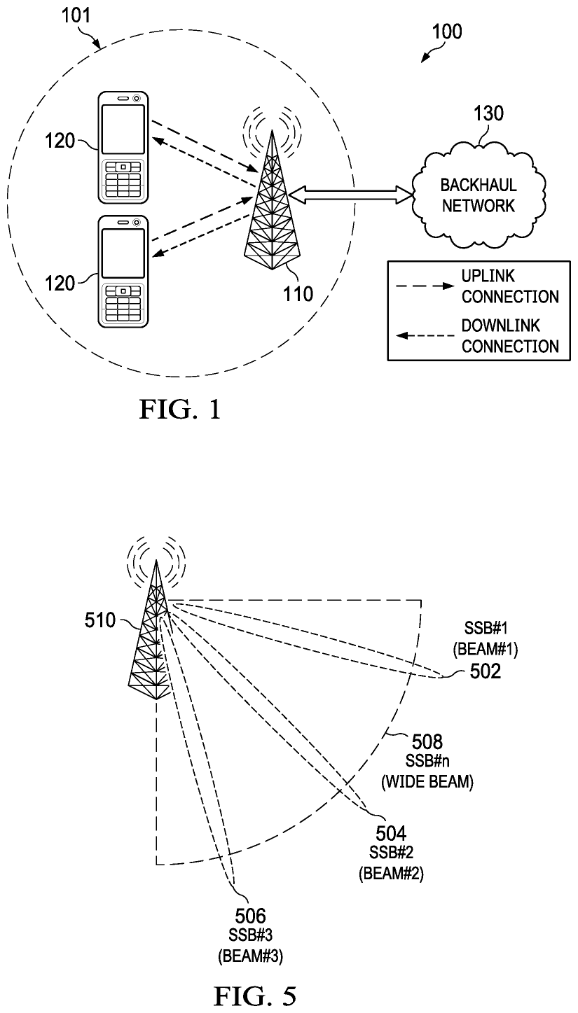

FIG. 1 is a diagram of a wireless network too for communicating data, according to some embodiments. The wireless network too includes a base station 110 having a coverage area 101, a plurality of mobile devices 120, and a backhaul network 130. As shown, the base station 110 establishes uplink (dashed line) and/or downlink (dotted line) connections with the mobile devices 120, which serve to carry data from the mobile devices 120 to the base station 110 and vice-versa. Data carried over the uplink/downlink connections may include data communicated between the mobile devices 120, as well as data communicated to/from a remote-end (not shown) by way of the backhaul network 130. As used herein, the term “base station” refers to any component (or collection of components) configured to provide wireless access to a network, such as an evolved NodeB (eNB), a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac. As used herein, the term “mobile device” refers to any component (or collection of components) capable of establishing a wireless connection with a base station. The terms “mobile device,” “user equipment (UE),” and “mobile station (STA)” are used interchangeably throughout this disclosure. In some embodiments, the network too may comprise various other wireless devices, such as relays.

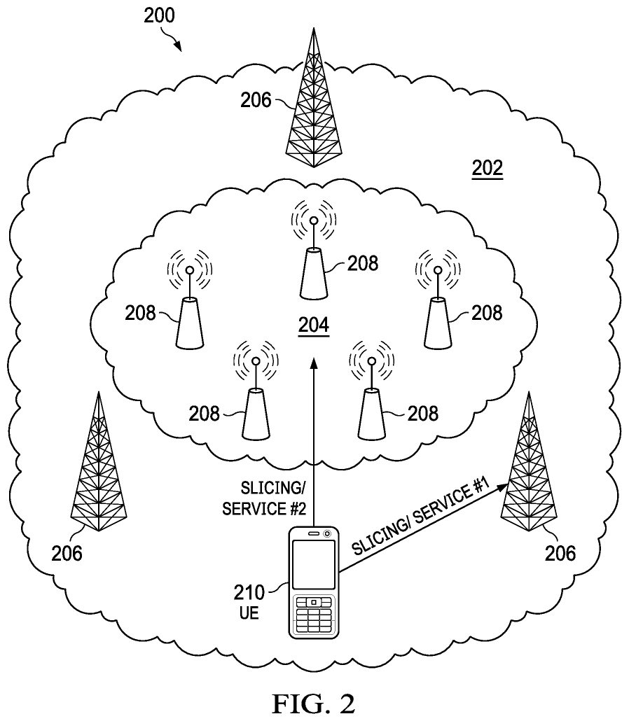

FIG. 2 illustrates an example network 200 with RAN slicing. In FIG. 2, the network 200 includes the RAN slice 202 and the RAN slice 204. The RAN slice 202 includes base stations 206 that provide a first type of service (e.g., an eMBB service). The RAN slice 204 includes transmit/receive points (TRPs) 208 that provide a second type of service. The second type of service may be different from the first type of service. For example, the second type of service may be a URLLC service. User equipment (UE) 210 may access the RAN slices 202 and 204. The UE 210 may support one or both of the first and second services provided by the RAN slices 202 and 204, respectively. For illustration purpose, FIG. 2 merely provides an example of RAN slicing with two RAN slices, and is not meant to be limiting. The network 200 may include more than two RAN slices providing more than two different services. For example, the network 200 may further include a third RAN slice (not shown) that provides a third service different from the first and second services. In addition, FIG. 2 shows the non-limiting example of two RAN slices having two different sets of base stations/TRPs. As mentioned above, a RAN slice may consist of one or more of the following components: one or more sets of transmit/receive nodes/points and user equipments (UEs); one or more sets of transmission schemes; one or more sets of time/frequency/beam/cell resources; mechanism of initial access procedures; mechanism of handover (HO) procedures; and one or more sets of state machines for managing UE states, such as the active state, the inactive (ECO) state, and the idle state.

FIG. 2 shows different RAN slices/services with different cells/layouts/carriers, according to some embodiments. These different sets of cells/layout/carriers may not be in synchronization or may be in tight synchronization. Different RAN slices/services may have different requirements on synchronization accuracy. Further, different RAN slices/services may have different sets of cells with different cell identifiers (IDs). In addition, different RAN slices/services may have different cell sizes/coverages and thus handover (HO) boundaries. The physical cells/carriers for different RAN slices/services may be the same or co-located.

From the UE perspective, different UEs may support different sets of services and may need to access different RAN slices. Some UEs may only support one type of RAN slice/service, such as an mMTC service, or a URLLC service. Other UEs may support multiple types of services, such as supporting an eMBB service and a URLLC service. For a UE supporting multiple types of services, the UE may access to the network via a default RAN slice/service (e.g., eMBB) first. Later, the UE may be configured to access to a secondary RAN slice/service.

As described above, in conventional systems, a UE supports only one synchronization channel in a network with multiple RAN slices/services. This conventional synchronization channel presents a technical challenge because one synchronization channel does not adapt well different service requirements (e.g., reliability, latency requirements) associated with different RAN slices/services. In embodiments of this disclosure, different RAN slices/services can support different synchronization channels. The network can configure different SYNC sweeping patterns/cycles based on UE distributions of different RAN slices.

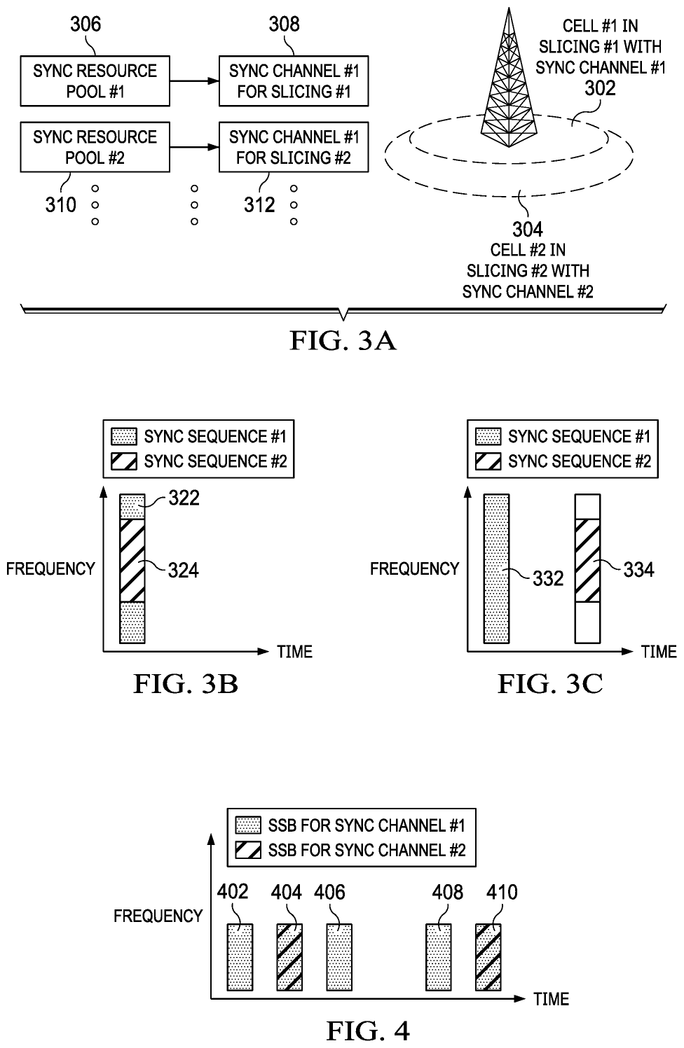

FIG. 3A shows examples of different synchronization channels for different RAN slices using different synchronization resources (time/frequency/sequence resources), according to some embodiments. Different synchronization channels for different RAN slices may be allocated and configured with different synchronization resources pools of time/frequency/sequence resources. In FIG. 3A, the RAN slice 302 of a RAN may use the synchronization channel 308 from the synchronization resource pool 306. A different RAN slice of the RAN may use a different synchronization channel from a different synchronization resource pool. For example, the RAN slice 304 of the RAN may use the synchronization channel 312 from the synchronization resource pool 310. For illustration purpose, FIG. 3A only shows two RAN slices and corresponding two different synchronization resource pools 306 and 308. A RAN could have more than two RAN slices and corresponding more than two different synchronization resource pools. For example, a third RAN slice (not shown) of the RAN may use a third synchronization channel from a third synchronization resource pool, and a fourth RAN slice of the RAN may use a fourth synchronization channel from a fourth synchronization resource pool, and so on.

FIG. 3B shows an example embodiment of different synchronization sequence sources for different synchronization channels on the same OFDM symbol. A first synchronization channel (e.g., the synchronization channel 308 for the RAN slice 302) may use a first synchronization sequence 322. A second synchronization channel (e.g., the synchronization channel 312 for the RAN slice 304) may use a second synchronization sequence 324. As FIG. 3B illustrates, the second synchronization sequence 324 may be partially extracted from the first synchronization sequence 322.

FIG. 3C shows another example embodiment of different synchronization sequence sources for different synchronization channels on different OFDM symbols. Different synchronization channels may use different synchronization sequences with the same or different lengths and transmitted on different symbols. In FIG. 3C, a first synchronization channel (e.g., the synchronization channel 308 for the RAN slice 302) may use a first synchronization sequence 332. A second synchronization channel (e.g., the synchronization channel 312 for the RAN slice 304) may use a second synchronization sequence 334 different from the first synchronization sequence 332. As FIG. 3C illustrates, the first synchronization sequence 332 and the second synchronization sequence 334 are transmitted on different symbols. Further, the first synchronization sequence 332 and the second synchronization sequence 334 have different lengths.

FIG. 4 illustrates an example embodiment of using different sets of synchronization signal blocks (SSBs) for different synchronization channels. FIG. 4 shows 5 SSBs for a RAN, the SSBs 402, 404, 406, 408, and 410. A first synchronization channel (e.g., the synchronization channel 308 for the RAN slice 302) may use a first subset of SSBs (e.g., all five of the SSBs 402, 404, 406, 408, and 410). A second synchronization channel (e.g., the synchronization channel 312 for the RAN slice 304) may use a different sub subset of SSB set that includes the SSBs 404 and 410.

FIG. 5 illustrates an example embodiment of using different beam resources for different synchronization channels. FIG. 5 shows three narrow beams from the base station 510: the narrow beams 502, 504, and 506. FIG. 5 also shows a wide beam 508 from the base station 510. A first synchronization channel (e.g., the synchronization channel 308 for the RAN slice 302) may use a subset of three SSBs transmitted on the set of the three narrow beams (e.g., the SSB #1 transmitted over the narrow beam 502, the SSB #2 transmitted over the narrow beam 504, and the SSB #3 transmitted over the narrow beam 506). A second synchronization channel (e.g., the synchronization channel 312 for the RAN slice 304) may use a different subset of SSBs (e.g., the SSB # n) transmitted over the wide beam 508.

Supporting multiple synchronization channels for different RAN slices can satisfy different requirements of different services associated with the different RAN slices. Using completely different or partially different time/frequency/sequence resources for different synchronization channels can achieve such design goal. With multiple synchronization channels for different RAN slices, the synchronization procedure for the UE to synchronize and access to different RAN slices may take different approaches.

Some embodiments take the approach of a two-step synchronization procedure. For the first step of the two-step synchronization procedure, the UE may synchronize on a first link using the default synchronization channel (e.g., the NR Release-15 synchronization channel). Then, the UE may obtain the configuration information of a second synchronization channel (or a third, or a fourth synchronization channel, etc.) through one or more of the system information, the radio resource control (RRC) configuration, or the slicing/service configuration messages. For the second step of two-step synchronization procedure, if the UE has the capabilities and if the UE needs to access a particular RAN slice/service, the UE may be configured/enabled by the network to synchronize on a second link using the second synchronization channel (e.g., the synchronization channel 308 in FIG. 3A) of that particular RAN slice/service (e.g., the RAN slice 302 in FIG. 3A). In one embodiment, instead of being enabled by the network, the UE may enable itself to synchronize on the second link using the second sync channel of that of that particular RAN slice/service.

Some embodiments take the approach of a one-step synchronization procedure. In these embodiments, the UE may synchronize directly on a first link of a particular RAN slice using a particular synchronization channel. Here, the particular synchronization channel used by the UE for the one-step synchronization procedure is different from the default synchronization channel (e.g. the NR Release-15 synchronization channel). That is, accessing the default synchronization channel can be bypassed in some embodiments of the one-step synchronization procedure. For UEs that use the one-step synchronization procedure, these UEs may not support full capabilities for NR functions. For example, a UE may only support one of a narrowband-Internet of things (NB-IOT) service, a URLLC service, or an mMTC service.

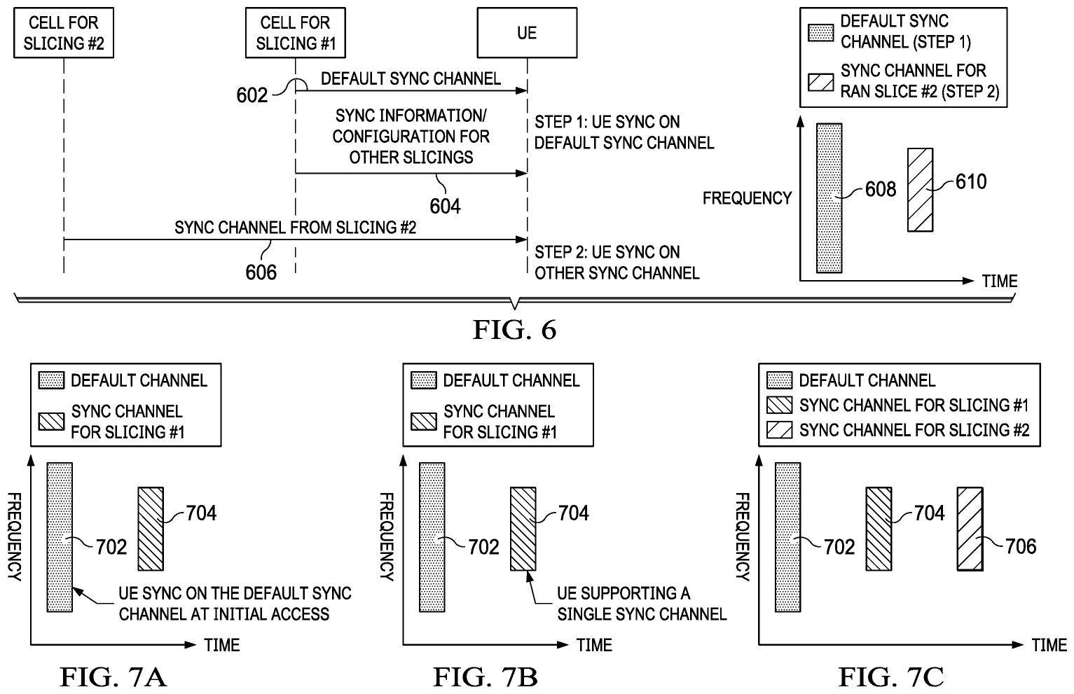

FIG. 6 illustrates the approach for the two-step synchronization procedure, according to some embodiments. At the step 602, a cell for the RAN slice #1 (e.g., the RAN slice 302 in FIG. 3A) may transmit to the UE default synchronization signals over the default synchronization channel 610 for the whole network supporting multiple RAN slices. The UE may first synchronize on the default synchronization channel. Alternatively, the cell for the RAN slice #1 may transmit to the UE synchronization signals over the RAN slice #1's own synchronization channel (not shown). The UE may synchronize on the RAN slice #1's own synchronization channel. Next, at the step 604, the network may send to the UE the synchronization configuration information for other RAN slices that the RAN supports. If the UE has the capabilities of supporting other RAN slices and services associated with these RAN slices, the UE may be enabled to synchronize on the synchronization channels associated with the other RAN slices. For example, at step 606, the UE may synchronize on the synchronization channel 610 of the RAN slice #2. In one embodiment, the synchronization channels for different RAN slices may be transmitted on different symbols using different resources including different sequences. For example, in FIG. 6, the default synchronization channel 608 used for the first step 602 and the synchronization channel 610 used for the second step 606 for different RAN slices are transmitted on different symbols using different sequence resources.

FIGS. 7A-7C illustrates further examples of the synchronization procedures for multiple RAN slices of a RAN, according to some embodiments. FIG. 7A shows that a UE may first synchronize on the default synchronization channel 702 at the initial access to the network. After the initial access, the UE may then be enabled to synchronize on other synchronization channels (e.g., the synchronization channel 704 in FIGS. 7A and 7B) that are associated with the different RAN slices/services for which the UE is configured/activated. As FIG. 7B further shows, the UE does not maintain synchronization on the default synchronization channel 702 if the UE does not support the service on the default RAN slice associated with the default synchronization channel 702. Alternatively, the UE may still maintain synchronization on the default synchronization channel 702 if the UE still supports the service on RAN slice associated with the default synchronization channel 702 (not shown in FIG. 7B).

FIG. 7C shows another alternative embodiment, where a UE may synchronize on multiple synchronization channels at the same time if the UE supports multiple RAN slices/services simultaneously. For example, if an UE supports a default RAN slice/service, a first RAN slice/service, and a second RAN slice/service simultaneously, the UE may at the same time synchronize on the default synchronization channel 702 associated with the default RAN slice/service, the first synchronization channel 704 associated with the first RAN slice/service, and the second synchronization channel 706 associated with the second RAN slice/service.

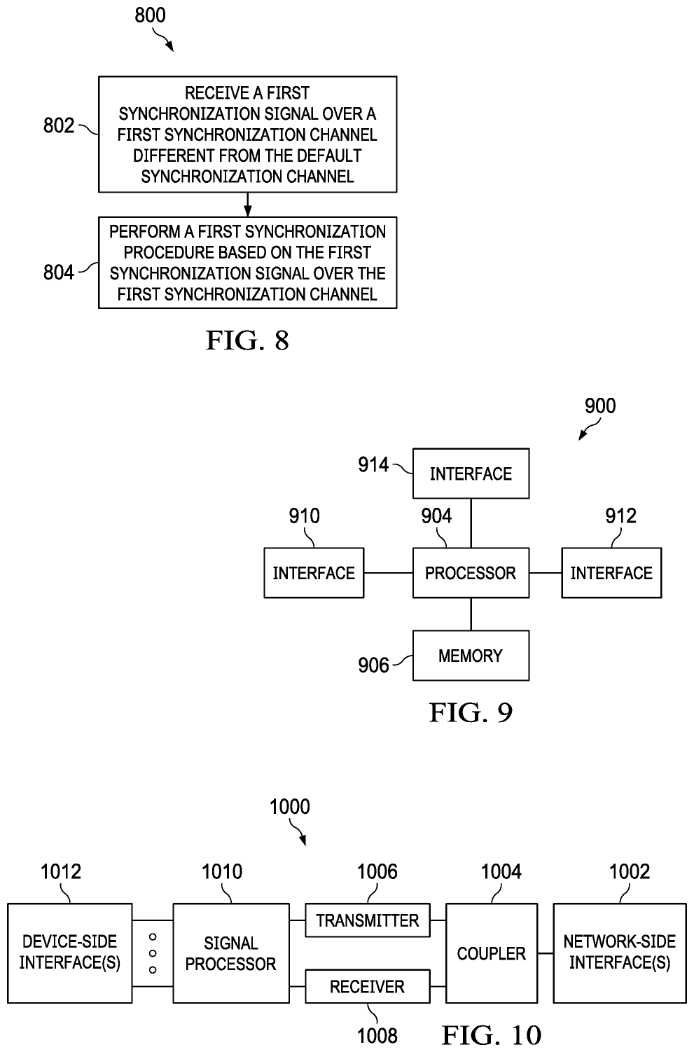

FIG. 8 is a flowchart of a method 800 for RAN slicing synchronization, according to some embodiments. The method 800 may be carried out or performed by hardware of a user equipment (UE), such as the UE 120 in FIG. 1. The method 800 may also be carried out or performed by routines, subroutines, or modules of software executed by one or more processors of the UE. The method 800 may further be carried out or performed by a combination of hardware and software. Coding of the software for carrying out or performing the method 800 is well within the scope of a person of ordinary skill in the art having regard to the present disclosure. The method 800 may include additional or fewer operations than those shown and described and may be carried out or performed in a different order. Computer-readable code or instructions of the software executable by the one or more processor of the UE may be stored on a non-transitory computer-readable medium, such as for example, memory of the UE.

FIG. 8 starts at the operation 802, where a user equipment (UE) receives, from a first transmit point in a radio access network (RAN), a first synchronization signal over a first synchronization channel. The first synchronization channel is associated with a first RAN slice of a plurality of RAN slices in the RAN. The plurality of RAN slices comprise a second RAN slice associated with a second synchronization channel. The first synchronization channel and the second synchronization channel are different from a default synchronization channel of the first transmit point.

At the operation 804, the UE performs a first synchronization procedure based on the first synchronization signal over the first synchronization channel, before the UE accesses a first service provided by the first RAN slice.

In some embodiments, before the UE receives the first synchronization signal over the first synchronization channel, the UE may receive a synchronization signal over the default synchronization channel. The plurality of RAN slices may comprise a default RAN slice associated with the default synchronization channel. The UE may perform a synchronization procedure based on the synchronization signal over the default synchronization channel before the UE accesses a default service provided by the default RAN slice. UE may receive configuration information of the first synchronization channel. The UE may then receive the first synchronization signal over the first synchronization channel associated with a first RAN slice as describe with the operation 802.

In some embodiments, to receive the configuration information of the first synchronization channel, the UE may receive the configuration information of the first synchronization channel in one of a system information message, a radio resource control (RRC) message, or a slicing configuration message.

In some embodiments, the first synchronization channel may be transmitted on a first bandwidth part (BWP). The second synchronization channel may be transmitted on a second BWP. The second BWP may be different from the first BWP.

In some embodiments, the first synchronization channel may use a first time-frequency resource. The second synchronization channel may use a second time-frequency resource. The second time-frequency resource may be different from the first time-frequency resource. In some embodiments, the first time-frequency resource may at least partially overlap with the second time-frequency resource.

In some embodiments, the first synchronization channel may use a first beam resource. The second synchronization channel may use a second beam resource. The second beam resource may be different from the first beam resource. In some embodiments, the first beam resource may at least partially overlap with the second beam resource. In some embodiments, the first beam resource may be associated with one or more narrow beams. The second beam resource may be associated with one or more wide beams.

In some embodiments, the first synchronization channel may use a first synchronization sequence. The second synchronization channel uses a second synchronization sequence. The second synchronization sequence may be different from the first synchronization sequence. In one embodiment, the second synchronization sequence may be partially extracted from the first synchronization, and the first and the second synchronization sequences may transmit on the same symbol. In another embodiment, the first and the second synchronization sequences may have different lengths and transmit on the same symbol. In yet another embodiment, the first and the second synchronization sequences may have different lengths and transmit on the different symbols.

In some embodiments, the first RAN slice provides a first set of one or more services. The first set of one or more services may have a first quality of service (QoS) requirement. The second RAN slice may provide a second set of one or more services. The second set of one or more services may have a second QoS requirement. The second QoS requirement may be different from the first QoS requirement. In some embodiment, the second QoS requirement may have a higher latency or a higher reliability requirement than the first QoS requirement. Examples of a QoS requirement include at least one of a latency requirement, a jitter requirement, a packet ordering requirement, a dropped-packet rate, a throughput requirement, or an error rate.

In some embodiments, different synchronization channels for different RAN slices may use different synchronization signal block (SSB) configurations. For example, the first synchronization channel may use a first SSB configuration. The second synchronization channel may use a second SSB configuration different from the first SSB configuration. The first SSB configuration and the second SSB configuration may both be different from a default SSB configuration used by the default synchronization channel.

In some embodiments, the UE may receive, from a second transmit point in the RAN, a second synchronization signal over a second synchronization channel. The second transmit point may be the same as or different from the first transmit point. The second synchronization channel may be associated with the second RAN slice of the plurality of RAN slices in the RAN. The UE may then perform a second synchronization procedure based on the second synchronization signal over the second synchronization channel, before the UE accesses a second service provided by the second RAN slice. In one embodiment, the UE may not maintain synchronization on the default synchronization channel after performing the second synchronization procedure if the UE does not support the service on the default RAN slice associated with the default synchronization channel. In another embodiment, the UE may still maintain synchronization on the default synchronization channel after performing the second synchronization procedure if the UE still supports the service on the default RAN slice associated with the default synchronization channel.

In some embodiments, the UE may receive, from a third transmit point in the RAN, a third synchronization signal over a third synchronization channel. The third transmit point may be the same as or different from the second transmit point or the first transmit point. The third synchronization channel may be associated with the third RAN slice of the plurality of RAN slices in the RAN. The UE may then perform a third synchronization procedure based on the third synchronization signal over the third synchronization channel, before the UE accesses a third service provided by the third RAN slice. The third RAN slice may provide a third set of one or more services. The third set of one or more services may have a third QoS requirement different from the first and the second QoS requirement. In one embodiment, the UE may synchronize on the default synchronization channel, the first synchronization channel, and the second synchronization channel at the same time. The third synchronization channel may use a third SSB configuration different from the default SSB configuration, the first SSB configuration, and the second SSB configuration.

FIG. 9 is a block diagram of an embodiment processing system 900 for performing methods described herein, which may be installed in a host device. As shown, the processing system 900 includes a processor 904, a memory 906, and interfaces 910-914, which may (or may not) be arranged as shown in FIG. 9. The processor 904 may be any component or collection of components adapted to perform computations and/or other processing related tasks, and the memory 906 may be any component or collection of components adapted to store programming and/or instructions for execution by the processor 904. In an embodiment, the memory 906 includes a non-transitory computer readable medium. The interfaces 910, 912, 914 may be any component or collection of components that allow the processing system 900 to communicate with other devices/components and/or a user. For example, one or more of the interfaces 910, 912, 914 may be adapted to communicate data, control, or management messages from the processor 904 to applications installed on the host device and/or a remote device. As another example, one or more of the interfaces 910, 912, 914 may be adapted to allow a user or user device (e.g., personal computer (PC), etc.) to interact/communicate with the processing system 900. The processing system 900 may include additional components not depicted in FIG. 9, such as long term storage (e.g., non-volatile memory, etc.).

In some embodiments, the processing system 900 is included in a network device that is accessing, or part otherwise of, a telecommunications network. In one example, the processing system 900 is in a network-side device in a wireless or wireline telecommunications network, such as a base station, a relay station, a scheduler, a controller, a gateway, a router, an applications server, or any other device in the telecommunications network. In other embodiments, the processing system 900 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 910, 912, 914 connects the processing system 900 to a transceiver adapted to transmit and receive signaling over the telecommunications network. FIG. 10 is a block diagram of a transceiver 1000 adapted to transmit and receive signaling over a telecommunications network. The transceiver 1000 may be installed in a host device. As shown, the transceiver 1000 comprises a network-side interface 1002, a coupler 1004, a transmitter 1006, a receiver 1008, a signal processor 1010, and a device-side interface 1012. The network-side interface 1002 may include any component or collection of components adapted to transmit or receive signaling over a wireless or wireline telecommunications network. The coupler 1004 may include any component or collection of components adapted to facilitate bi-directional communication over the network-side interface 1002. The transmitter 1006 may include any component or collection of components (e.g., up-converter, power amplifier, etc.) adapted to convert a baseband signal into a modulated carrier signal suitable for transmission over the network-side interface 1002. The receiver 1008 may include any component or collection of components (e.g., down-converter, low noise amplifier, etc.) adapted to convert a carrier signal received over the network-side interface 1002 into a baseband signal. The signal processor 1010 may include any component or collection of components adapted to convert a baseband signal into a data signal suitable for communication over the device-side interface(s) 1012, or vice-versa. The device-side interface(s) 1012 may include any component or collection of components adapted to communicate data-signals between the signal processor 1010 and components within the host device (e.g., the processing system 1000, local area network (LAN) ports, etc.).

The transceiver 1000 may transmit and receive signaling over any type of communications medium. In some embodiments, the transceiver 1000 transmits and receives signaling over a wireless medium. For example, the transceiver 1000 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1002 comprises one or more antenna/radiating elements. For example, the network-side interface 1002 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1000 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a sending unit/module, a selecting unit/module, an assigning unit/module, an incrementing unit/module, a decrementing unit/module, and/or an accessing unit/module. The respective units/modules may be hardware, software, or a combination thereof. For instance, one or more of the units/modules may be an integrated circuit, such as field programmable gate arrays (FPGAs) or application-specific integrated circuits (ASICs).

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a sending unit/module, a selecting unit/module, an assigning unit/module, an incrementing unit/module, a decrementing unit/module, and/or an accessing unit/module. The respective units/modules may be hardware, software, or a combination thereof. For instance, one or more of the units/modules may be an integrated circuit, such as field programmable gate arrays (FPGAs) or application-specific integrated circuits (ASICs).

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method, the method comprising:
receiving, by a user equipment (UE) from a first transmit point in a radio access network (RAN), a first synchronization signal over a first synchronization channel, the first synchronization channel associated with a first RAN slice of a plurality of RAN slices in the RAN, wherein the plurality of RAN slices comprise a second RAN slice associated with a second synchronization channel, and the first synchronization channel and the second synchronization channel are different from a default synchronization channel of the first transmit point; and
performing, by the UE, a first synchronization procedure based on the first synchronization signal over the first synchronization channel before accessing a first service provided by the first RAN slice.

2. The method of claim 1, further comprising:
before the receiving the first synchronization signal:
receiving, by the UE, a synchronization signal over the default synchronization channel, wherein the plurality of RAN slices comprise a default RAN slice associated with the default synchronization channel;
performing, by the UE, a synchronization procedure based on the synchronization signal over the default synchronization channel before accessing a default service provided by the default RAN slice; and
receiving, by the UE, configuration information of the first synchronization channel.

3. The method of claim 2, wherein the receiving the configuration information of the first synchronization channel comprises receiving the configuration information of the first synchronization channel in one of a system information message, a radio resource control (RRC) message, or a slicing configuration message.

4. The method of claim 1, wherein the first synchronization channel is transmitted on a first bandwidth part (BWP), and the second synchronization channel is transmitted on a second BWP.

5. The method of claim 1, wherein the first synchronization channel uses a first time-frequency resource, and the second synchronization channel uses a second time-frequency resource different from the first time-frequency resource.

6. The method of claim 5, wherein the first time-frequency resource at least partially overlaps with the second time-frequency resource.

7. The method of claim 1, wherein the first synchronization channel uses a first beam resource, and the second synchronization channel uses a second beam resource different from the first beam resource.

8. The method of claim 7, wherein the first beam resource at least partially overlaps with the second beam resource.

9. The method of claim 1, wherein the first synchronization channel uses a first synchronization sequence, and the second synchronization channel uses a second synchronization sequence different from the first synchronization sequence.

10. The method of claim 1, wherein the first RAN slice provides a first set of one or more services having a first quality of service (QoS) requirement, and the second RAN slice provides a second set of one or more services having a second QoS requirement different from the first QoS requirement.

11. The method of claim 1, wherein the first synchronization channel uses a first synchronization signal block (SSB) configuration, the second synchronization channel uses a second SSB configuration different from the first SSB configuration, and the first SSB configuration and the second SSB configuration are different from a default SSB configuration used by the default synchronization channel.

12. A user equipment (UE) comprising:
a non-transitory memory storage comprising instructions; and
one or more processors in communication with the non-transitory memory storage, wherein the one or more processors execute the instructions to perform operations, the operations comprising:
receiving, from a first transmit point in a radio access network (RAN), a first synchronization signal over a first synchronization channel, the first synchronization channel associated with a first RAN slice of a plurality of RAN slices in the RAN, wherein the plurality of RAN slices comprise a second RAN slice associated with a second synchronization channel, and the first synchronization channel and the second synchronization channel are different from a default synchronization channel of the first transmit point; and
performing a first synchronization procedure based on the first synchronization signal over the first synchronization channel before accessing a first service provided by the first RAN slice.

13. The UE of claim 12, the operations further comprising:
before the receiving the first synchronization signal:
receiving a synchronization signal over the default synchronization channel, wherein the plurality of RAN slices comprise a default RAN slice associated with the default synchronization channel;
performing a synchronization procedure based on the synchronization signal over the default synchronization channel before accessing a default service provided by the default RAN slice; and
receiving configuration information of the first synchronization channel.

14. The UE of claim 13, wherein the receiving the configuration information of the first synchronization channel comprises receiving the configuration information of the first synchronization channel in one of a system information message, a radio resource control (RRC) message, or a slicing configuration message.

15. The UE of claim 12, wherein the first synchronization channel is transmitted on a first bandwidth part (BWP), and the second synchronization channel is transmitted on a second BWP.

16. The UE of claim 12, wherein the first synchronization channel uses a first time-frequency resource, and the second synchronization channel uses a second time-frequency resource different from the first time-frequency resource.

17. The UE of claim 16, wherein the first time-frequency resource at least partially overlaps with the second time-frequency resource.

18. The UE of claim 12, wherein the first synchronization channel uses a first beam resource, and the second synchronization channel uses a second beam resource different from the first beam resource.

19. The UE of claim 18, wherein the first beam resource at least partially overlaps with the second beam resource.

20. The UE of claim 12, wherein the first synchronization channel uses a first synchronization sequence, and the second synchronization channel uses a second synchronization sequence different from the first synchronization sequence.

21. The UE of claim 12, wherein the first RAN slice provides a first set of one or more services having a first quality of service (QoS) requirement, and the second RAN slice provides a second set of one or more services having a second QoS requirement different from the first QoS requirement.

22. The UE of claim 12, wherein the first synchronization channel uses a first synchronization signal block (SSB) configuration, the second synchronization channel uses a second SSB configuration, and the first SSB configuration and the second SSB configuration are different from a default SSB configuration used by the default synchronization channel.

23. A non-transitory computer-readable medium having instructions stored thereon that, when executed by a user equipment (UE), cause the UE to perform operations, the operations comprising:
receiving, from a first transmit point in a radio access network (RAN), a first synchronization signal over a first synchronization channel, the first synchronization channel associated with a first RAN slice of a plurality of RAN slices in the RAN, wherein the plurality of RAN slices comprise a second RAN slice associated with a second synchronization channel, and the first synchronization channel and the second synchronization channel are different from a default synchronization channel of the first transmit point; and
performing a first synchronization procedure based on the first synchronization signal over the first synchronization channel before accessing a first service provided by the first RAN slice.
